(19) United States
(12) Patent Application Publication
(10) Pub. No.: US 2020/0236540 A1
(43) Pub. Date: Jul. 23, 2020

(54) Electronic Record Exposure Validation Using Cross-Referenced Location Data

(71) Applicant: C-4 Analytics, LLC, Swampscott, MA (US)

(72) Inventor: Justin Cook, Swampscott, MA (US)

(21) Appl. No.: 16/844,536

(22) Filed: Apr. 9, 2020

Related U.S. Application Data
(63) Continuation-in-part of application No. 15/066,528, filed on Mar. 10, 2016.

(51) Int. Cl. H04W 12/02; H04L 29/08; H04W 4/029; H04W 4/021; H04W 64/00; H04W 12/10; H04W 12/00

(52) U.S. Cl. CPC H04W 12/02; H04L 67/18; H04W 4/029; H04W 12/00503; H04W 64/003; H04W 12/1004; H04W 4/021

(57) ABSTRACT

The exposure of computing device users to electronic records is validated using cross-referenced location data for those users. A location of a first mobile device is received from a software application running on the first mobile device. A data repository external to the first mobile device is queried based on the location of the first mobile device to identify a vendor operating at the location of the first mobile device. After the vendor is identified, an exposure of an electronic record associated with the vendor is determined, such as at the first mobile device or at a second mobile device related by a common user account. Based on a determination that the electronic record exposure occurred, an intelligence platform model is updated to indicate a successful exposure of the electronic record, such as to cause a further exposure of the electronic record to other devices.

### CROSS-REFERENCE TO RELATED APPLICATION(S)

The present disclosure is a continuation-in-part of U.S. patent application Ser. No. 15/066,528, filed Mar. 10, 2016, entitled “Proximity Detection System and Method,” the disclosure of which is herein incorporated by reference.

### TECHNICAL FIELD

The present disclosure relates to validation of electronic record exposure using cross-referenced location data.

### BACKGROUND

Advances in computing technology have made it commonplace for mobile devices to access the Internet and view or otherwise interact with online electronic data. Commercial entities are able to reach past and prospective customers using new media for attracting attention, such as offering interactive games or videos on their websites or by placing advertisements on various third-party websites targeted to those customers. Data indicative of a person's online viewing records and interactions can be used to provide meaningful suggestions for other websites to browse or goods to purchase through online vendors. However, this Internet-centric data has offline application, as well.

### SUMMARY

Disclosed herein are aspects of systems and techniques for electronic record exposure validation using cross-referenced location data.

One aspect of the disclosure is a method, comprising: receiving a location of a first mobile device from a software application running on the first mobile device; querying a data repository external to the first mobile device based on the location of the first mobile device to identify a vendor operating at the location of the first mobile device; responsive to the identification of the vendor, determining whether a second mobile device has been exposed to an electronic record associated with the vendor, wherein the first mobile device and the second mobile device are shared by a common user account previously accessed at both of the first mobile device and the second mobile device; and responsive to a determination that the second mobile device has been exposed to the electronic record, updating an intelligence platform model to indicate a successful exposure of the electronic record to a user associated with the common user account.

Another aspect of the disclosure is a method, comprising: transmitting, from a server device, a request for location data to a first mobile device running a software application; responsive to the request for the location data, receiving, at the server device, the location data from the first mobile device; parsing, at the server device, the location data from the mobile device to identify a location of the first mobile device; cross-referencing, at the server device, the location of the first mobile device against locations of vendors to identify a vendor operating at the location of the first mobile device using map information of a map application running on an external device; determining that the first mobile device is related to a second mobile device by validating a common user account accessed at both of the first mobile device and the second mobile device; transmitting, from the server device, a request for exposure data for a second mobile device, the exposure data including data based on an exposure, at the second mobile device, of an electronic record associated with the vendor operating at the location of the first mobile device; responsive to the request for the exposure data for the second mobile device, receiving, at the server device, the exposure data; and processing, at the server device, the exposure data for the second mobile device to determine a successful exposure of a user of the first mobile device and of the second mobile device to the electronic record.

Another aspect of the disclosure is a method, comprising: determining, based on exposure data for a mobile device, that the mobile device has been exposed to an electronic record; detecting, based on location data received from a software application running on the mobile device, a location of the mobile device; identifying, by querying for map information used by a map application, a vendor operating at the location of the mobile device, wherein the vendor is associated with the electronic record; and updating, based on the identification of the vendor, an intelligence platform model to cause a further exposure of the electronic record to one or more other devices.

Details of these implementations, modifications of these implementations and additional implementations are described below.

### BRIEF DESCRIPTION OF THE DRAWINGS

The description herein makes reference to the accompanying drawings, where like reference numerals refer to like parts throughout the several views, and where:

FIG. 1 is a block diagram of an example computing network usable within implementations of the present disclosure;

FIG. 2 is a perspective view of a storage enclosure for housing computing equipment usable within implementations of the present disclosure;

FIG. 3 is a block diagram of a digital data processing machine usable within implementations of the present disclosure;

FIG. 4 is a diagram showing data being communicated between an example user device and an example proximity detection system;

FIG. 5 is a diagram of example data associated with an example user device usable within implementations of the present disclosure;

FIG. 6 is a block diagram of an example intelligence dashboard usable within implementations of the present disclosure;

FIG. 7 is a flowchart showing an example method for using an implementation of the present disclosure for detecting a physical presence of a device used to view an electronic record;

FIG. 8 is a block diagram of an example system for electronic record exposure validation using cross-referenced location data according to implementations of the present disclosure; and

FIG. 9 is a flowchart showing an example method for using an implementation of the present disclosure for electronic record exposure validation using cross-referenced location data.

### DETAILED DESCRIPTION

Data indicative of a person's online viewership and interactions with electronic records provide useful insight to his or her interests. In the context of online advertising, there are significant difficulties associated with effectively correlating online advertising viewership or interaction with offline shopping activity. For example, although a commercial entity may easily be able to monitor and identify its customers' online habits, for example, by tracking viewing and interaction with online advertisements or websites associated with the commercial entity, in a physical store context, it generally must rely upon a customer identifying an online advertisement as a reason or basis for his or her offline traffic. Even where the customer is capable of accurately describing online advertising or website viewership, manual data entry must be done for each customer to properly identify trends in online advertisements for offline attribution. Further, the effectiveness of an online advertisement campaign cannot be properly measured where data indicative of an Internet user's viewership of online content associated with the commercial entity is not correlated.

One solution for measuring the effectiveness of online advertising includes associating unique identifiers with Internet users and monitoring online advertisement viewership and interaction based on those identifiers. After an Internet user travels to a physical store associated with the online advertisements and makes an offline purchase, data indicative of the purchase may eventually be associated with the user's unique identifier. This information can be analyzed well after a transaction is completed to assess whether the online advertisements may have had an effect on facilitating the offline purchase. Still, this solution suffers from numerous drawbacks and shortcomings. First, that solution does not include any way to identify retail store customers who have previously viewed online advertisements or websites related to a commercial entity while those customers are still in the retail store. For example, it would be highly desirable to identify customers present in or near a retail store who have not yet completed a transaction and who have previously viewed an online advertisement associated with the commercial entity or the goods sold thereby prior to entering the store. Identifying these customers early in a shopping experience may provide ample opportunity for the commercial entity to increase sales made to them, for example, by focusing on or expanding from topics of interest identified by their online viewership and interactions.

Second, that solution does not include any way to determine the efficacy of an online advertising campaign in which an online advertisement is viewed, but not interacted with, by a user of user device. For example, it would be highly desirable to determine that the user of a user device on which an online advertisement was viewed but not interacted with later visited a commercial entity related to the online advertisement, such as using information related to online advertisement exposure for the user device and using location data for the user device.

Implementations of the present disclosure include systems and methods for detecting a device used for viewing electronic records within a near proximity of a physical location. Data indicative of viewership and/or interaction with electronic records, such as online advertisements associated with a commercial entity, can be identified from a user device detected over a network or other communication system. The proximity of the user device with respect to a physical location, such as a bricks-and-mortar retail store, associated with the commercial entity can be detected along with a duration of time that the proximity of the user device was so detected. This data can be correlated immediately upon detection or within a nearly immediate time thereafter to determine a user of the user device's exposure to the electronic records. Data indicative of the proximity of the user device with respect to the physical location and the duration of the proximity may be correlated with sales to identify attributions for online advertising impressions based on offline customer traffic and/or sales in the physical location.

The implementations of the present disclosure further provide meaningful improvements in the modeling of platform intelligence based on electronic record exposure such as by validating electronic record exposure using cross-referenced location data. A location of a first mobile device is received from a software application running on the first mobile device. A data repository external to the first mobile device is queried based on the location of the first mobile device to identify a vendor operating at the location of the first mobile device. After the vendor is identified, an exposure of an electronic record associated with the vendor is determined, such as at the first mobile device or at a second mobile device related by a common user account. Based on a determination that the electronic record exposure occurred, an intelligence platform model is updated to indicate a successful exposure of the electronic record, such as to cause a further exposure of the electronic record to other devices.

The systems and methods of the present disclosure address problems particular to the Internet, for example, those concerning attribution of offline customer traffic and sales to online advertising viewership or interaction. These Internet-specific issues can be solved by implementations of the present disclosure. For example, the aforesaid attribution can be facilitated by detecting devices associated with customer viewership and interaction. The development of new ways to present online advertisements is fundamentally related to the Internet; however, the nature of online advertising renders offline attribution difficult, as information about a customer in a physical store's online viewership and interaction records are not apparent to the commercial entity. Implementations of the present disclosure can thus provide a way to technically and efficiently attribute electronic record exposure.

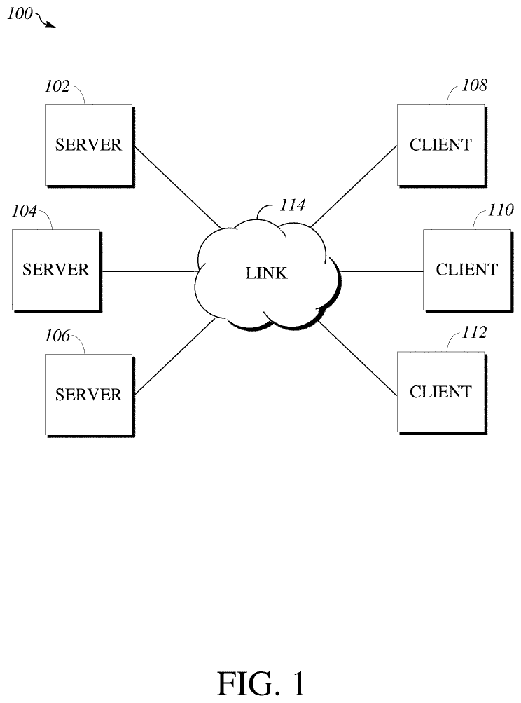

To describe some implementations in greater detail, reference is first made to examples of hardware structures and interconnections usable with implementations of the present disclosure. FIG. 1 is a block diagram of an example computing network 100. Computing network 100 includes various computer resources including servers 102, 104, 106 and client computers 108, 110, 112 (also referred to as clients) interconnected to computing network 100 and each other via telecommunications link 114. One example of link 114 is the public Internet, and other examples include multiple local area networks, wide area networks, Intranets, Extranets, Internetworks, Wi-Fi networks, or any other suitable technology using wires, radiofrequency, microwave, satellite, cellular, optical, or other telecommunications systems. Computing network 100 includes digital data storage, which may be represented by one or more of servers 102, 104, 106. Examples of the hardware components and interconnections of servers 102, 104, 106, clients 108, 110, 112, and various data storage are discussed in detail below. In some implementations, servers 102, 104, 106 store and manage client data. Client data may be stored in a single site, location, or device. Alternatively, client data may be distributed among different sites, locations, or devices.

Servers 102, 104, 106 can be computers on which a website or portions of a website (e.g., content, advertisements, etc.) are located. In some implementations, servers 102, 104, 106 can be application layers of servers for loading instances of websites or portions of website. Clients 108, 110, 112 can be computers on which the website or portions of the website are viewed, for example, by navigating an Internet browser to a web address. In some implementations, clients 108, 110, 112 are mobile devices, such as smart phones, tablets, laptop computers, personal digital assistants, handheld gaming devices, etc. In some implementations, clients 108, 110, 112 are non-mobile devices, such as desktop computers, server computers, non-handheld gaming devices, printers, scanners, etc. In some implementations, link 114 includes communication between the servers of computing network 100 (e.g., between servers 102, 104, 106) and/or between the clients of computing network 100 (e.g., between clients 108, 110, 112).

In some implementations, computing network 100 may be applied to the task of cloud computing. Cloud computing may provide various advantages over traditional computing models, including the ability to allocate shared resources amongst many different customers. Under traditional computing models, computing resources are typically allocated to a single customer or entity and substantial portions of those resources may remain unused or underused.

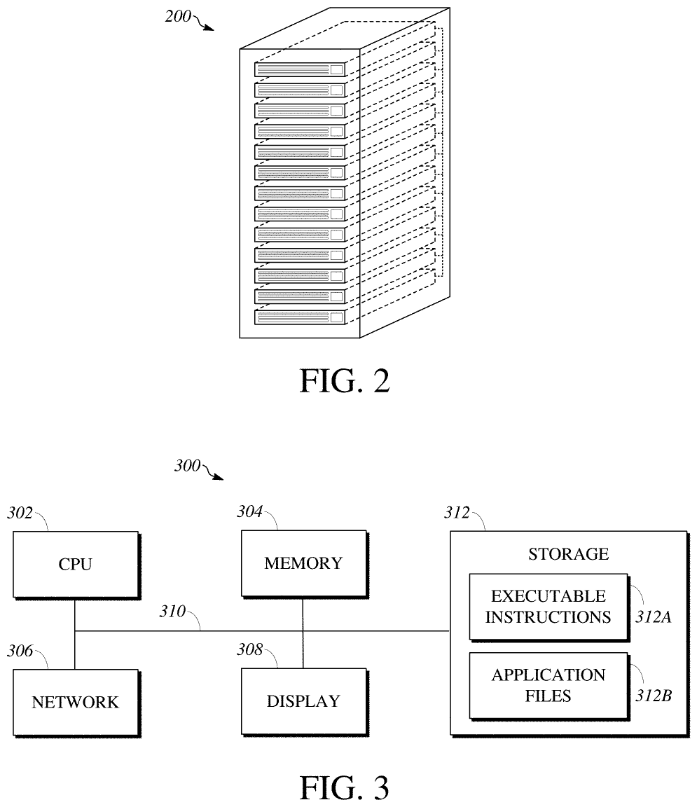

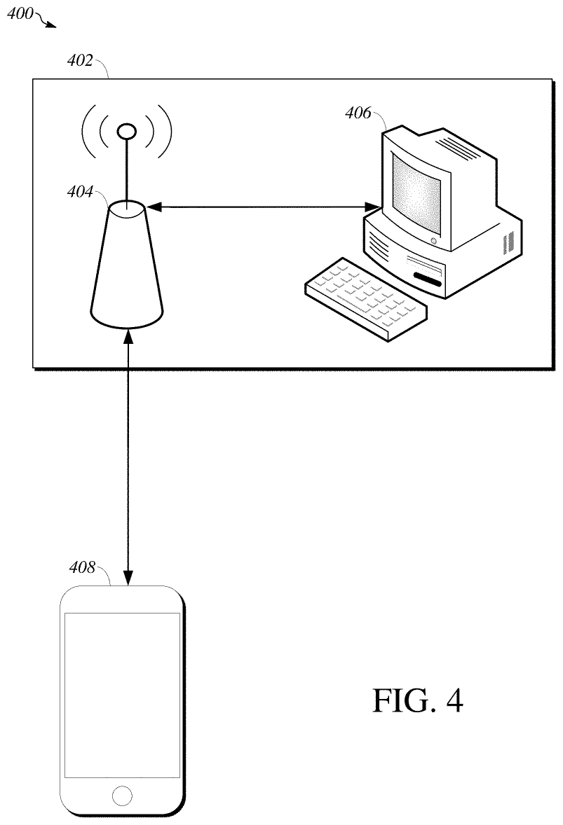

The data processing components of this disclosure, including the computing network of FIG. 1, may be implemented by various hardware devices. The makeup of these subcomponents is described in greater detail below, with reference to FIGS. 2 and 3. FIG. 2 is a perspective view of a storage enclosure for housing computing equipment usable within implementations of computing network 100. FIG. 2 shows a storage enclosure 200 housing computer servers, such as one or more of servers 102, 104, 106. One implementation of this structure includes a computer hardware rack or other storage enclosure, frame, or mounting that houses rack mounted servers. In this example, the computer servers include their own power supplies and network connections. Another implementation includes a blade enclosure containing blade servers. The blade enclosure includes power supplies, cooling units, and networking components shared by the constituent blade servers. A control center (not shown) may be included to supervise or manage operations of the racked computer servers.

FIG. 3 is a block diagram of a digital data processing machine or device 300 usable within implementations of computing network 100. Device 300 may be implemented by one or more computing devices such as a mobile telephone, a tablet computer, laptop computer, notebook computer, desktop computer, server computer, mainframe computer, computer workstation, and the like.

In some implementations, device 300 includes CPU 302, memory 304, storage 312, network 306, display 308, and bus 310. One example of CPU 302 is a conventional central processing unit. CPU 302 may include single or multiple processors each having single or multiple processing cores. Alternatively, CPU 302 may include another type of device, or multiple devices, capable of manipulating or processing information now-existing or hereafter developed.

Memory 304 may comprise RAM or any other suitable type of storage device. The memory 304 may include executable instructions and data for immediate access by CPU 302. Memory 304 may include one or more DRAM modules such as DDR SDRAM. Alternatively, memory 304 may include another type of device, or multiple devices, capable of storing data for processing by CPU 302 now-existing or hereafter developed. CPU 302 may access and manipulate data in memory 304 via bus 310.

Storage 312 may include executable instructions 312A and application files 312B along with other data. Executable instructions 312A may include, for example, an operating system and one or more application programs for loading in whole or part into memory 304 and to be executed by CPU 302. The operating system may be, for example, Windows, Mac OS X, Linux, or another operating system suitable to the details of this disclosure. The application programs may include, for example, a web browser, web server, database server, and other such programs. Some examples of application files 312B include client/user files, database catalogs, and configuration information. Storage 312 may comprise one or multiple devices and may utilize one or more types of storage, such as solid state or magnetic.

The internal configuration may also include one or more input/output devices, such as network 306 and display 308. Network 306 and display 308 may be coupled to CPU 302 via bus 310, in one example. Network 306 may, for example, include a network interface and may take the form of a wired network interface such as Ethernet or a wireless network interface. Other output devices that permit a client/user to program or otherwise use the client or server may be included in addition to or as an alternative to display 308. When the output device is or includes a display, the display may be implemented in various ways, including by a LCD, CRT, LED, OLED, etc.

Other implementations of the internal architecture of clients and servers are also possible. For example, servers may omit display 308 as well as client programs such as web browsers. Operations of CPU 302 may be distributed across multiple machines which may be coupled directly or across a local area or other network. Memory 304 and/or storage 312 may be distributed across multiple machines such as network-based memory or memory in multiple machines performing the operations of clients or servers. Although depicted here as a single bus, bus 310 may be composed of multiple buses.

Various instances of digital data storage may be used to provide storage internal and/or external to the components previously described and illustrated. Depending upon its application, such digital data storage may be used for various functions, such as storing data and/or storing machine-readable instructions. These instructions may themselves support various processing functions, or they may serve to install a software program upon a computer, where such software program is thereafter executable to perform other processing functions related to this disclosure.

In any case, the storage media may be implemented by nearly any mechanism to digitally store machine-readable signals. One example is optical storage such as CD-ROM, WORM, DVD, digital optical tape, disk storage, or other optical storage. Another example is direct access storage, such as a conventional “hard drive”, redundant array of inexpensive disks (RAID), or another direct access storage device (DASD). Another example is serial-access storage such as magnetic or optical tape. Still other examples of digital data storage include electronic memory such as ROM, EPROM, flash PROM, EEPROM, memory registers, battery backed-up RAM, etc.

In some implementations, a storage medium is coupled to a processor so the processor may read information from, and write information to, the storage medium. In the alternative, the storage medium may be integral to the processor. In another example, the processor and the storage medium may reside in an ASIC or other integrated circuit.

In contrast to storage media that contain machine-executable instructions, as described above, a different embodiment uses logic circuitry to implement some or all of the processing features described herein. Depending upon the particular requirements of the application in the areas of speed, expense, tooling costs, and the like, this logic may be implemented by constructing an application-specific integrated circuit (ASIC) having thousands of integrated transistors. Such an ASIC may be implemented with CMOS, TTL, VLSI, or another suitable construction. Other alternatives include a digital signal processing chip (DSP), discrete circuitry (such as resistors, capacitors, diodes, inductors, transistors, and the like), field programmable gate array (FPGA), programmable logic array (PLA), programmable logic device (PLD), and the like.

More particularly, one or more clients or servers or other machines described herein may include an ASIC or programmable logic array such as a FPGA configured as a special-purpose processor to perform one or more of the operations or steps described or claimed herein. An exemplary FPGA may include a collection of logic blocks and RAM blocks that may be individually configured and/or configurably interconnected in order to cause the FPGA to perform certain functions. Certain FPGAs may contain other general or special purpose blocks as well. An exemplary FPGA may be programmed based on a hardware definition language (HDL) design, such as VHSIC Hardware Description Language or Verilog.

Certain operational aspects of the disclosure will now be described with reference to FIGS. 4 through 6. FIG. 4 is a diagram 400 showing data being communicated between an example user device 408 and an example proximity detection system 402. In some implementations, proximity detection system 402 comprises detector 404 and computing system 406. In some implementations, proximity detection system comprises a single device for detecting other devices and processing data communicated thereby. Proximity detection system 402 can be located entirely within a single physical location, for example, a physical store, or within multiple physical locations, for example, where detector 404 is located at a physical store and computing system 406 is located in a data center or other facility.

Detector 404 can be a device for detecting other devices, for example, those within a near proximity of detector 404. In some implementations, detector 404 comprises a wireless network router and a controller, including a transceiver for communicating data received by a first device (e.g., user device 408) to a second device (e.g., computing system 406). In some implementations, the transceiver comprises a sensor for detecting devices in communication with detector 404. The sensor can be used to detect a signal communicated by user device 408, such as a probe transmitted for identifying communication systems for connecting to a computing network, or an indication that user device 408 has connected to a communication system associated with detector 404. The sensor may also or instead be used to monitor a physical condition of a component usable with a computing network to which detector 404 is connected, for example, by measuring a temperature of a CPU, memory, or storage for a server associated with detector 404. In some implementations, the detector can be a network device (e.g., a router), an integrated special purpose device, a system comprising a network routing device and a server, or any other suitable device for recognizing data communicable by a first device to a second device. In some implementations, data communicated by user device 408 to computing system 406 is not communicated through detector 404; rather, detector 404 can be used to validate or authenticate user device 408 in order to allow for the direct or indirect communication between user device 408 and computing system 406.

Although detector 404 is above described as a device for detecting other devices within a near proximity of detector 404, the detection of such other devices may be limited or improved based on a power of detector 404. Thus, proximity can depend upon the implementation and power of detector 404. For example, where detector 404 is very powerful, it may be configured to detect such other devices within a city block or larger region. However, where detector 404 is minimally powerful, it may only be configured to detect such other devices within a specific room of a physical store, or, if possible, the physical store and adjoining parking or walking areas, as applicable.

Computing system 406 can be a computer or group of computers for processing data communicated by user device 408. For example, computing system 406 can be used to identify data communicated by or from user device 408 to determine whether user device 408 has been used to view electronic records related to a commercial entity associated with proximity detection system 402. In some implementations, computing system 406 comprises software for customer relationship management for customers of the commercial entity. In some implementations, computing system 406 comprises or is configured to communicate data received from user device 408 to one or more analytics systems for aggregating, analyzing, and otherwise processing the data received from user device 408. In some implementations, computing system 406 is comprised on a same device as detector 404. In some implementations, computing system 406 and detector 404 comprise separate devices.

User device 408 can be a device for use by one or more people and can be a client computer, such as one of clients 108, 110, 112 of FIG. 1. In some implementations, user device 408 is an Internet-enabled mobile device. References throughout this disclosure may describe or otherwise refer to user device 408 as a smartphone, however any other type of device, whether explicitly, implicitly, or not described in this disclosure, can be user device 408. For example, in some implementations, user device 408 can be a vehicle driven by a user. User device 408 is associated with one or more people, or users, based at least in part on the user(s) carrying user device 408 or otherwise having access to it. References throughout this disclosure may describe or otherwise refer to user device 408 as being associated with a single user having registered a profile or account or otherwise being the primary user of user device 408, however any other type of user, whether explicitly, implicitly, or not described in this disclosure, can be the user associated with user device 408.

Diagram 400 depicts a general flow of data between user device 408, detector 404, and computing system 406. In some implementations, before data may be communicated by or from user device 408, user device 408 may first be required to connect to a network associated with proximity detection system 402. In some implementations, such as where detector 404 comprises a network router, connecting to the network may include the user device 408 becoming connected to the network using a service set identifier (SSID) associated therewith. In some implementations, detector 404 may be able to detect user device 408 without user device 408 being required to connect to any network associated with detector 404, for example, by leveraging a connection with a different communication system usable by user device 408. In some implementations, and as will be discussed below in greater detail, communication between user device 408 and proximity detection system 402 can be established in other ways, for example, by detector 404 detecting data indicative of a location of user device 408 communicated by or in connection with a software application executed on user device 408.

In some implementations, data may be communicated from detector 404 to user device 408, for example, to indicate that detector 404 has received data from user device 408 or that user device 408 has successfully connected to a network associated with detector 404. Similarly, in some implementations, data may be communicated from computing system 406 to detector 404, for example, to indicate that computing system 406 has received data from user device 408 or detector 404 or that data indicative of a network associated with detector 404 has been changed in some way.

In some implementations, proximity detection system 402 can be used to identify electronic records previously viewed on, by, or otherwise in connection with user device 408 prior to user device 408 being detected, for example, within a near proximity of a physical location. For example, where the physical location is a physical store of a particular commercial entity, upon detector 404 detecting user device 408, computing system 406 can determine whether an electronic record, such as one or more of online content, a website, an advertisement, etc., associated with the commercial entity has previously been displayed at user device 408. Data indicative of this previous displaying, referred to herein as exposure data, may be communicated, passively or actively, and directly or indirectly, to computing system 406 by or from user device 408 or another device. Examples of exposure data which may be processed by computing system 406 to determine a previous displaying of an electronic record at user device 408 include, but are not limited to, demand data (e.g., demand side platform data or demand management platform data) or browsing data (e.g., data communicated from user device 408 to a server (e.g., of computing system 406 or an external system) and/or locally stored at user device 408). Computing system 406 can process the exposure data to determine that the electronic records previously viewed using user device 408 pertain to the commercial entity. For example, where the exposure data includes browsing data, computing system 406 may identify cookies, metadata, or other computer code or instructions indicative of user device 408 having been used to browse a website, which may be a first-party website of the commercial entity on which it describes its goods or services, or a third-party website on which those goods or services are described, for example, through an advertisement.

In some implementations, computing system 406 may compare the exposure data associated with user device 408 to data known to be associated with various first- and third-party websites related to the commercial entity (e.g., by matching the source of the data communicated by or from user device 408 to that of the first- or third-party website). In this way, proximity detection system 402 can assist a commercial entity in understanding whether a customer (e.g., a user of user device 408) is present in the physical store because of something he or she previously viewed online. Proximity detection system 402 can further identify trends in viewership to determine the effectiveness of various electronic records, for example, based on the sources associated with the most frequently identified electronic record viewing data.

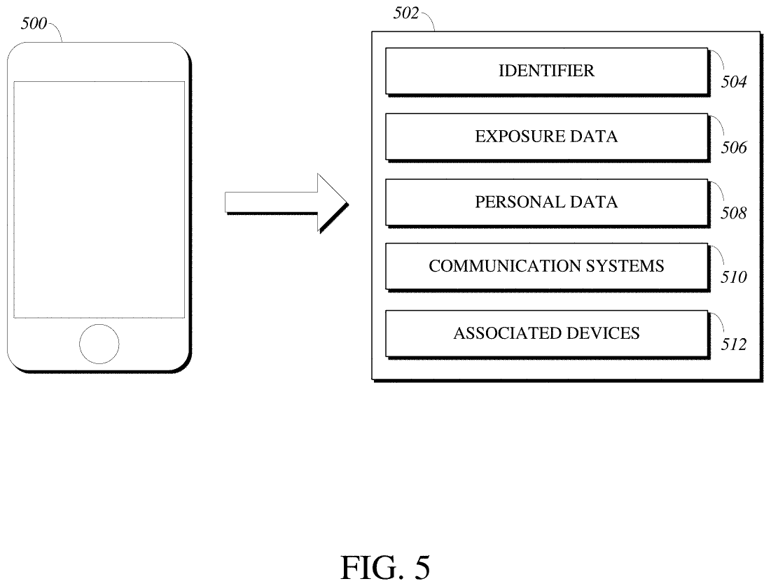

FIG. 5 is a diagram of example data associated with an example user device usable within implementations of the present disclosure. As discussed above, device 500 represents a user device, such as an Internet-enabled mobile device, which can be connected as a client to computing network 100. Data 502 can include any data useful for identifying device 500 (e.g., over link 114 of computing network 100) and determining electronic records previously viewed on, by, or otherwise in connection with device 500. In some implementations, data 502 comprises identifier 504, exposure data 506, personal data 508, communication systems 510, and associated devices 512.

Identifier 504 can be an identifier representative of and/or associated with user device 500. In some implementations, identifier 504 can be a unique identification, such as a media access control (MAC) address or device fingerprinting code, for identifying the device. In some implementations, identifier 504 can be an identifier shared by multiple devices (e.g., as part of a group or collection of devices, such as devices belonging to a company or school), for example, wherein the identifier identifies user device 500 as part of a group or collection, such as where the identifier is associated with the group or collection of devices in a database. A second identifier may be included in that or other implementations for specifying user device 500 from amongst multiple devices, for example, wherein the first identifier comprises an identification code indicative of user device 500 being part of a group or collection and the second identifier comprises a MAC address of user device 500.

In some implementations, identifier 504 is representative of user device 500 as well as a user associated with user device 500. For example, where multiple users use user device 500 (e.g., where it is detected that user device 500 includes multiple registered profiles or accounts), identifier 504 may be paired to user device 500 and a particular user profile or account. In some implementations, a first identifier may be used to identify user device 500 and a second identifier for identifying the particular user. In some implementations, identifier 504 comprises a promotional code particular to a user registered with an online portal of a commercial entity. Regardless of the particular implementation, identifier 504 provides a way for a proximity detection system to identify user device 500 as being user device 500 and not some other device connected over an associated communication system.

Exposure data 506 locally stored at device 500 is browsing data indicative of a user's online browsing history, habits, viewership, interactions, etc. However, other examples of exposure data 506 are possible, such as where exposure data 506 is communicated from device 500 to a server or where exposure data 506 derives from a device other than device 500 (e.g., a server associated with a commercial entity, demand side platform, or demand management platform). Exposure data 506 is indicative of electronic records previously output for display at user device 500. Electronic records include first-party websites, third-party websites (e.g., those including online advertisements associated with a commercial entity), online advertisements generally, media (e.g., pictures, sound files, videos, games, etc.), or any other type of electronic communication, whether text, video, graphic, sound, or any combination of the foregoing, and whether commercial, entertainment-based, academic, governmental, or otherwise. In some implementations, an electronic record can comprise an online advertisement or other communication or only a portion of an online advertisement or other communication. In some implementations, an electronic record can be a static or dynamic record generated or otherwise selected by user device 500 or a source of the electronic record. In some implementations, an electronic record can be interactive with a user of user device 500. In some implementations, the electronic record can be pushed or pulled onto user device 500 by or from the source of the electronic record.

Personal data 508, also referred to as personal information, can be any data indicative of a user of user device 500. For example, personal data 508 can include any information that may or may not be publicly available about the user himself or herself, such as his or her name, mailing address, shipping address, zip code, email address, employer, trade or industry, website usernames, favorite websites, past purchases, billing history, credit card information, etc. In some implementations, personal data 508 can be included as part of exposure data 506, for example, as part of or in association with a previous display of an electronic record at device 500. In some implementations, personal data 508 can be used to fill in gaps in exposure data 506, for example, by identifying information about the user's Internet browsing habits not already indicated by exposure data 506.

Communication systems 510 can be communication systems available for use or actively used by device 500. Any type of communication system can be usable with the present disclosure, including, without limitation, Internet, intranet, Ethernet, WiFi, Bluetooth, radio frequency, near field communication (NFC), code division multiple access (CDMA), global system for mobile communications (GSM), long-term evolution (LTE), or any other suitable communication system. In some implementations, communication systems 510 comprises a wireless network on which device 500 is in communication with a proximity detection system, such as proximity detection system 402 of FIG. 4. Communication systems 510 can be limited by the hardware configurations particular to device 500, which, in some implementations, can be extended by the addition of further components. For example, components for boosting or improving a communication signal identifiable by device 500 may be added thereto, or components for introducing a communication system not previously known to device 500 may be added, such as where new frequencies for wireless communication are conceived.

Associated devices 512 can be other devices associated with the user of user device 500 or associated with user device 500 irrespective of the particular user. For example, associated devices 512 can comprise other electronic devices (e.g., mobile devices, wearable devices, or other devices) owned and/or operated by the user of user device 500, other electronic devices from which the user has been identified as an online customer of the commercial entity, electronic devices included within a group or collection of devices of which user device 500 is included, etc. In some implementations, data indicative of electronic records previously output for display at associated devices 512 (e.g., whether viewed or unviewed or interacted or not interacted by the user of the associated devices 512) can be identified based on an association with user device 500. In some implementations, data associated with associated devices 512 can further be used to provide further sales opportunities after the user of user device 500 has left the physical store. For example, the commercial entity may communicate offers related to the user's offline traffic and/or sales to associated devices 512 for future online and/or offline sales opportunities.

Although data 502 is illustrated as being associated with device 500, data 502 may be associated with any device, machine, or client within computing network 100. While data 502 is shown as including data items 504, 506, 508, 510, and 512, other data elements not shown or herein disclosed may also be associated with a device. For example, in some implementations, data 502 may further comprise metadata indicative of a past display of electronic records on device 500, data indicative of probing activities of device 500 (e.g., for communicating data between device 500 and another device, such as detector 402 of FIG. 4), data indicative of a user of device 500 beyond personal data 508, etc. Similarly, it may be the case that the data associated with a device of computing network 100 does not include one or more of the data items shown or that it includes data elements not shown and excludes data elements that are shown. However, each device usable within computing network 100 has associated therewith at least some data elements.

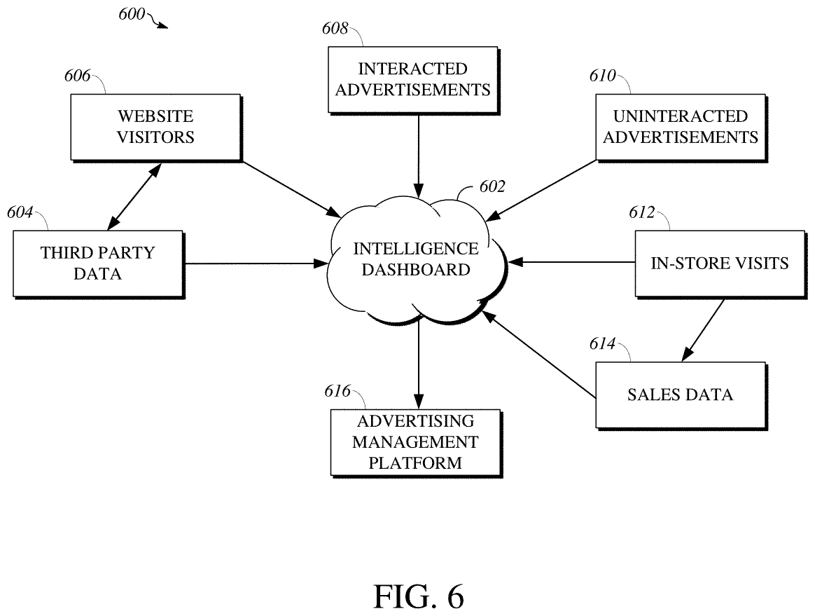

Data related to an Internet user's viewership and/or interactions with electronic records (e.g., exposure data 506 and/or other data) can be uploaded or otherwise communicated to and thereafter maintained, monitored, and otherwise analyzed by a central system, such as an intelligence dashboard. FIG. 6 is a block diagram 600 of an example intelligence dashboard 602 usable within implementations of the present disclosure. Intelligence dashboard 602 provides an opportunity for commercial entities to evaluate advertising campaigns and electronic records generally associated with them to identify effectiveness, for example, based on customer trends. In some implementations, intelligence dashboard 602 is a cloud-based system for tracking offline customer traffic and/or sales and correlating data indicative of same with online behavior. In some implementations, intelligence dashboard 602 comprises instructions executed on a server, such as one of servers 102, 104, 106 of FIG. 1. In some implementations, intelligence dashboard uses and processes information including third party data 604, website visitors 606, interacted advertisements 608, uninteracted advertisements 610, in-store visits 612, and sales data 614, such as by using advertising management platform 616.

Initial data for identifying viewership and interaction of electronic records may be derived from third party data 604 and website visitors 606. In some implementations, third party data 604 comprises information unrelated to goods or services offered by a commercial entity, but which could have an effect on supply, demand, pricing, or some other aspect of commerce. For example, third party data 604 may include an indication of upcoming holidays, weather events, material changes in gasoline prices, unavailability of resources, etc. In some implementations, third party data 604 could also or instead include information that may be related to the commercial entity's goods or services. For example, where the commercial entity deals in automobile insurance, inventory data received from a third party automobile trader may be useful for deciding advertising campaigns to introduce online. Similarly, in some implementations, third party data 604 can have a direct effect on advertisements associated with intelligence dashboard 602. For example, where certain goods sold by the commercial entity are provided from a particular third party and third party data 604 indicates that such third party is out of stock of those goods, third party data 604 can be used to cease advertising those goods until the stock is replenished.

Website visitors 606 can be data indicative of the persons who visit websites related to the commercial entity, for example, the entity's own first-party websites, third-party websites related to the goods or services of the entity (e.g., a competitor's website), third-party websites unrelated to those goods or services that include some association with the commercial entity (e.g., by including an advertisement, content, or other electronic record for the commercial entity), etc. In some implementations, website visitors 606 can include data indicative of third party data 604, for example, where persons visiting the websites had previously viewed online content related to third party data 604.

Interacted advertisements 604 includes data indicative of electronic records that have been interacted with by a user. In some implementations, interaction as used in the preceding sentence refers to any action taken with respect to the electronic record beyond merely viewing it, for example, clicking on or otherwise selecting an electronic record (e.g., to navigate between pages of a first-party website, to load a new website from an advertisement, banner, or other electronic record related to a third-party website, to cause some change to occur with respect to the electronic record, etc.). In contrast, uninteracted advertisements 606 includes, for a given electronic record which has been output for display at a user device or associated device, data indicative of an instance of viewing the electronic record and not considered as being interacted advertisements 604, such as because the electronic record was not interacted with. For example, where a user is merely browsing a website that happens to have an advertisement for a commercial entity located thereon but does not click on or otherwise select the advertisement, the advertisement can be considered an uninteracted advertisement.

In-store visits 612 includes data indicative of a visit to a physical store by a user who had previously viewed an electronic record. In some implementations, the determination that the user had previously viewed an electronic record can be made based on one or more of third party data 604, website visitors 606, interacted advertisements 608, or uninteracted advertisements 610. In some implementations, in-store visits indicate certain data to intelligence dashboard for use in updating or otherwise monitoring advertising campaigns and other electronic records, including without limitation information about which in-store customer has viewed which first- or third-party website, whether or not an in-store customer interacted with an advertisement or merely viewed it, and whether any third-party websites or information lead the customer to the commercial entity. In some implementations, data indicative of in-store visits 612 can be communicated from a user device of a customer physically present in a physical store, for example, by receiving data from the user device over a communication system, such as WiFi, Bluetooth, etc. In some implementations, data indicative of in-store visits 612 may be used to further identify sales data 614, for example, where a customer in a physical store who had previously viewed an electronic record completes a sales transaction. Sales data 614 can include information about the goods or services purchased, including make, model, quantity, date, and any other relevant characteristics. Thus, in-store visits 612 (and sales data 614) can be indicative of the effectiveness of online advertisements attributed to offline traffic and/or sales.

In some implementations, in-store visits 612 may further detail aspects of a customer's visit to a physical store. For example, in-store visits may comprise data representative of a duration of time that the customer spent visiting the physical store, whether it was the customer's first time in the store, a date of last visit (to the extent applicable), a time at which the customer arrived at the store, and locations in the store that the customer perused. In some implementations, in-store visits 612 may be used to track multiple customers at once to identify a total number of customers present in the physical store at a given time.

Advertising management platform 616 can receive data from intelligence dashboard 602 to manage and update advertising campaigns and other electronic records based on the data collected, maintained, and monitored in diagram 600. For example, the data can be used to identify campaigns that did not reach targets, customers who were exposed to advertising but did not enter a physical store in response to the exposure, and determine the effectiveness or advertisements based in part on their frequency and placement. In some implementations, advertising management platform 616 comprises a recommendation engine and a media mix updater. The recommendation engine can be used to make changes to advertising campaigns and electronic records generally based on the data processed through intelligence dashboard 602. The media mix updater can be used to communicate these changes to first- and third-party websites to effect the changes. The media mix updater may comprise scripts and other programmable instructions for interacting with third-party websites, for example, to request changes to advertisements or other content located thereon. In some implementations, the media mix updater can be included as part of the recommendation engine or vice versa.

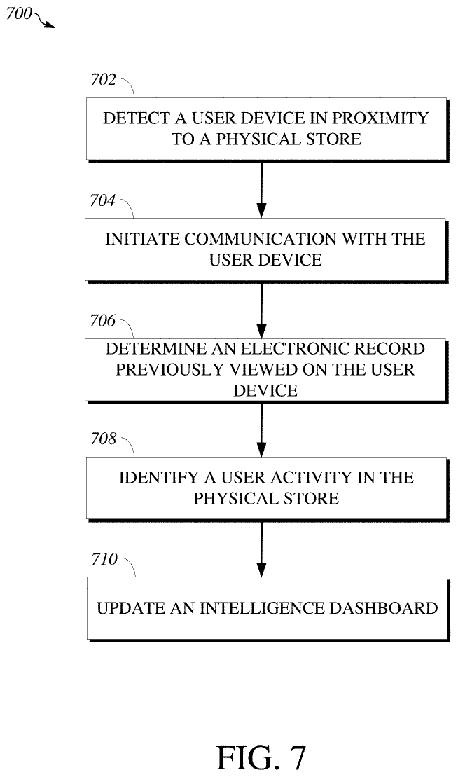

Further implementations of the disclosure will now be described with reference to FIG. 7. The steps, or operations, of any method, process, or algorithm described in connection with the embodiments disclosed herein may be embodied directly in hardware, firmware, software executed by hardware, circuitry, or a combination of these. Broadly, method 700 of FIG. 7 can be used to perform certain monitoring and analysis in computing network 100. In some implementations, method 700 may be performed using machines and hardware such as the equipment of FIGS. 1 through 5. Method 700 may be performed, for example, by executing a machine-readable program of JavaScript, C, or other such instructions. Implementations of the present disclosure may include multiple of the above-described features.

For ease of explanation, method 700 is depicted and described as a series of operations. However, operations in accordance with this disclosure may occur in various orders and/or concurrently. Additionally, operations in accordance with this disclosure may occur with other operations not presented and described herein. Furthermore, not all illustrated operations may be required to implement a method in accordance with the disclosed subject matter.

FIG. 7 is a flowchart showing an example method 700 for using an implementation of the present disclosure for detecting a physical presence of a device used to view an electronic record. At operation 702, a user device is detected in proximity to a detector. In some implementations, the user device is detected in proximity to a physical store wherein the detector is located. In some implementations, detection of the user device occurs in response to the user device emitting a signal or probe searching for a connection to a communication system, such as WiFi, Bluetooth, etc. For example, the user device may broadcast a ping or probe (e.g., one time, continuously, periodically, non-periodically, or otherwise) during regular operation, wherein, upon being detected within a sufficient proximity from the detector, the probe initializes a connection to a network associated with the detector.

In some implementations, the physical presence of the user device used to view an electronic record is detectable without requiring any software to be installed beyond what is necessary for accessing the Internet on the device. For example, where the device is an Internet-enabled mobile device, the present disclosure does not require that a mobile application for detecting the mobile device by a sensor be first installed. Rather, features already present on a typical mobile device can be used to communicate the data necessary for the operation of implementations of the present disclosure. In some implementations, a user is not required to take any active action to prepare the device for detection by the sensor. For example, the user need not select any options to configure the device for detection or otherwise opt-in to participate in detection. However, the probe can only be broadcast (and the user device detected) when communication channels are open on the user device. For example, to detect the user device over a WiFi network, the user device must have WiFi enabled.

In some implementations, the location of the user device can be detected irrespective of a WiFi connection operated at a computing device within a physical location. For example, the computing device can receive location data communicated by or from the user device indicative of a latitude and longitude coordinate of the user device. In some implementations, the location data can be communicated by or from a software application passively or actively executed on the user device. In some implementations, the location data can be communicated by or from a geolocation component of the user device, such as a global positioning system (GPS) chip integrated within the user device, or from a navigation application utilizing such geolocation component. In some implementations, the location data can be communicated based on a user response to an operating system request for location information, for example, as part of a request made via an application programming interface (API) of the operation system executed on the user device, for example, for an external device (e.g., the computing device in the physical location, etc.) to obtain location information of the user device. In some implementations, for example, where a software application operated in connection with the computing device or a server in communication with the computing device is installed on the user device, the location data can be communicated in response to the user responding to a location request of the software application API (e.g., requesting that the user opt-in to sharing the location data). In some implementations, the location data can be obtained from cellular carrier towers, for example, by triangulating signals indicative of a location of the user device. In some implementations, the location data communicated per the foregoing or other implementations can be stored in a database operated in connection with the proximity detection system, for example, to maintain location data of the user for future use.

In some implementations, detecting the user device comprises identifying an identifier representative of the device. The identifier may be used later on, for example, to determine electronic records previously viewed on the user device.

At operation 704, communication is initiated with the user device, for example, by the detector or a computing system in communication with the detector. In implementations wherein the detector is a network device, such as a router, the detector may communicate data representative of the network back to the user device in response to receiving the probe. For example, the detector may indicate an SSID representative of the network for the user device to join. The network may not require that a password or active authentication be entered or performed; rather, in some implementations, connection to the network is passive. In some implementations, communication between the device and the detector is enabled in response to the identification of the identifier of the device.

At operation 706, one or more electronic records previously viewed on (e.g., by the outputting of the electronic record(s) to a display of) the user device is determined using exposure data for the user device. The exposure data may, for example, be or include browsing data communicated by or otherwise received from the user device. In some implementations, determining the electronic records is done based on browsing data including tracking information, such as cookies, included in connection with online advertisements or websites. For example, any cookies or other tracking information may be probed to identify a list of online advertisements or websites (or other electronic records) that have previously been viewed on or by the user device. In some implementations, other types of exposure data may be used, such as exposure data derived from a device other than the user device (e.g., from a server of a demand side platform or of a demand management platform). In some implementations, determining the electronic records is done based on the identifier of the device. For example, the identifier can be compared against a list of identifiers maintained by a database or other store of an online advertising network to determine a number of times that the user device has viewed an electronic record and a list of electronic records that have been viewed by the user device. Thus, it can be determined by this comparison whether electronic records associated with the commercial entity operating the physical store in which the device is detected have been viewed on the device prior to detection.

This system can be used to determine whether the user device has viewed first-party or third-party websites, online advertisements on third-party (or other) websites, other online content, etc. associated with the commercial entity. In some implementations, a degree to which the electronic record made an impression on the user may be discernable based on whether the user interacted with an electronic record. For example, where the electronic record is an online advertisement, it can be determined whether the user clicked on or otherwise selected the advertisement or merely viewed it without interaction.

Implementations of the present disclosure may not require that a user enter personal information when viewing the electronic record using the user device. For example, in implementations wherein the device is a mobile device and the electronic record is a first-party website of an advertiser, the user does not need to enter personal information (e.g., name, credit card number, shipping address, etc.) on the website in order for the present disclosure to be able to identify him or her; rather, an identifier of the mobile device, such as a MAC address, associated with the user can be used to identify the user using implementations of the present disclosure. Notwithstanding the foregoing, in some implementations, the present disclosure may supplement the identifier of the device with personal information entered by a user to validate an identity of the user. For example, the identifier of the user device may be used to identify the user and the personal information entered by the user can be used to validate it.

In some implementations, determining prior viewership or interaction with an electronic record may further comprise determining whether the electronic record was viewed or interacted with on a second device associated with the user device. The association between the user device and the second device may be based on a determination that one or more shared user accounts registered on the user device are also registered on the second device, that personal data representative of the user of the user device matches that of the second device, that the same shared user account has been utilized (e.g., by the user logging into an email account) on each of the user device and the second device, or any other suitable manner for determining the association. In some implementations, the user device can be correlated to one or more second devices based on the identifier of the user device. For example, the user may be asked to opt-in to an offer or program delivered using a messaging service that records the identifier of each device to which the messages are sent.

At operation 708, a user activity occurring within the physical store is identified. The user activity can be any activity related to the customer traffic and/or offer for purchase of goods or services by or in connection with the user of the user device. For example, user activity may be identified to determine the goods displayed for sale that the user has looked at for a prolonged period of time. In some implementations, the detector can identify movement of the device within a near proximity of the detector. For example, the detector can determine that the device is moving based on a strength of a signal communicated by the device or by the detector (e.g., using an association with a SSID). Alternatively, user activity may be indicative of a completed transaction for the purchase of those goods. In some implementations, data indicative of whether a customer made a purchase while present in a physical store can include electronic data derived from electronic coupons (e.g., those communicated to an email address associated with the customer), online payments made by the customer (e.g., as determined based on personal data used at the time of payment), quick response (QR) codes communicated to the customer and including data indicative of the customer (e.g., as including personal data about the customer in the code), data scanned by in-store scanners, or data received from a point-of-sales or other payment application (e.g., whether an in-store feature or as a mobile application interfacing therewith). By identifying completed transactions made by users who had previously viewed an electronic record for the commercial entity, correlations can be made to determine positive efficacy of advertising campaigns (e.g., to identify a positive return on investment relative to a campaign).

At operation 710, an intelligence dashboard (e.g., intelligence dashboard 602 of FIG. 6) can be updated to reflect data indicative of one or more of the user device being detected in the physical store, the occurrence of a user activity within the physical store, or any other useful information identified (e.g., by proximity detection system 402 of FIG. 4). In some implementations, this update data can be used to base further marketing and advertisement decisions. In some implementations, this update data can be aggregated with previously known or stored intelligence data to update statistics about advertising efficacy. In some implementations, this update data can be used to better understand an individual customer's online and offline browsing behaviors, goods or services of interest, etc.

In some implementations, the intelligence dashboard may maintain records indicative of online and offline behaviors of monitored customers. For example, various aspects of customer behavior can be analyzed based on previously viewed electronic records and offline user activities in-store, such as overall in-store customer traffic based on electronic records (e.g., by the hour, day, week, month, etc.), real time in-store customer numbers, temporal durations during which user devices were detected (e.g., by total, average, etc.), whether the customers were new or returning customers, the communication systems most used for detecting customers in-store, and so on. Personal information about the customers may also be gathered, for example, gender, age, number of times having visited the physical store (and/or online store component, to the extent applicable), contact information, preferred messaging types, and so on. Other aspects of customer behavior may be analyzed as desired, such as the names or total number of people who previously viewed an electronic record but left the physical store too quickly for a transaction to be completed.

In some implementations, the data updated to and maintained by the intelligence dashboard can be used to assess the value and effectiveness of a media mix of electronic records (e.g., the specific arrangement, location, frequency, etc., of online advertisements on first- and third-party websites). That is, the effectiveness of an electronic record can be determined based on user activity online and offline. For example, based on data identified using method 700, it can be determined whether a customer was ever exposed to an online advertisement related to a commercial entity. If the customer interacted with the online advertisement, that information is denoted, as is information indicating that the customer did not interact with it. The intelligence dashboard may keep track of instances wherein a customer visited the commercial entity's first-party website in response to viewing an online advertisement, interacting with an online advertisement, and/or visiting a third-party website first.

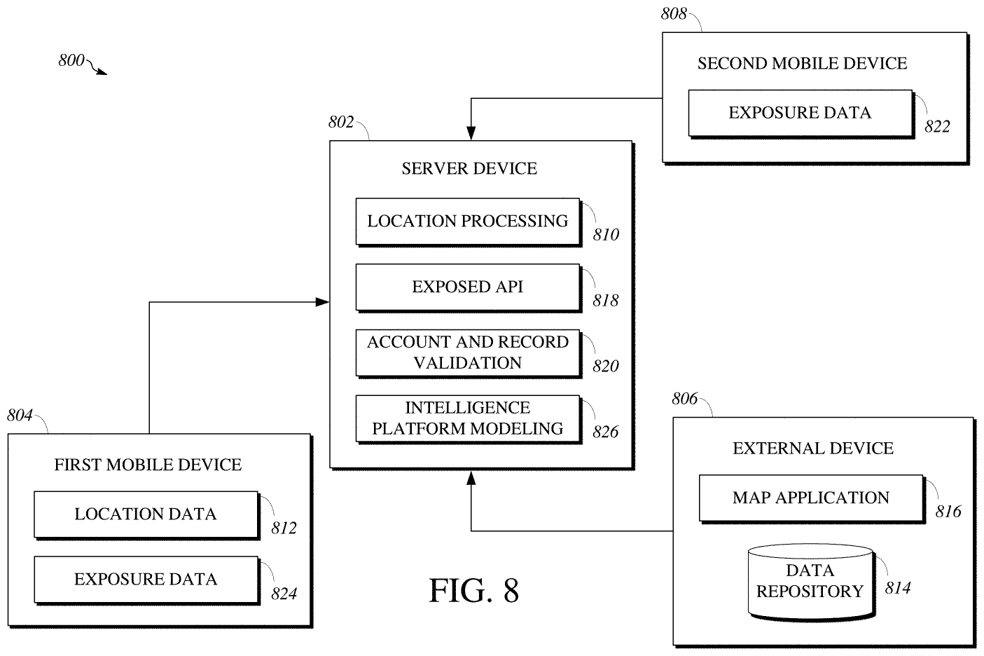

FIG. 8 is a block diagram of an example system 800 for electronic record exposure validation using cross-referenced location data according to implementations of the present disclosure. The system 800 includes hardware and software used to analyze the success of electronic record exposure campaigns including by determining whether a mobile device to which an electronic record is exposed or a related mobile device is detected at a location of a vendor associated with that electronic record. The system 800 includes a server device 802, a first mobile device 804, and an external device 806. In some implementations, the system 800 further includes a second mobile device 808. As described herein, the use of the term “includes” to describe a relationship between a component shown in FIG. 8 and the system 800 itself does not necessarily mean that the practice of the system 800 requires the possession, control, and/or operation of the components shown in FIG. 8. Rather, the components shown in FIG. 8 are or otherwise refer to components which can be used with the system 800, for example, in connection with processing performed at the server device 802.

Each of the first mobile device 804 and the second mobile device 806 is a mobile computing device featuring network connectivity. In some implementations, the first mobile device 804 and the second mobile device 806 are both smartphone devices. In some implementations, the first mobile device 804 and the second mobile device 806 are both wearable devices. In some implementations, the first mobile device 804 and the second mobile device 806 are both tablet devices. In some implementations, the first mobile device 804 is a smartphone device and the second mobile device 806 is a wearable device. In some implementations, the first mobile device 804 is a smartphone device and the second mobile device 806 is a tablet device. In some implementations, the first mobile device 804 is a wearable device and the second mobile device 806 is a smartphone device. In some implementations, the first mobile device 804 is a wearable device and the second mobile device 806 is a tablet device. In some implementations, the first mobile device 804 is a tablet device and the second mobile device 806 is a smartphone device. In some implementations, the first mobile device 804 is a tablet device and the second mobile device 806 is a wearable device.

The server device 802 includes a location processing unit 810 which processes location data 812 received from the first mobile device 804 to identify a location of the first mobile device 804. For example, the location processing unit 810 can use the location data 812 to determine latitude and longitude coordinates of the first mobile device 804 at a given time. The location data 812 may, for example, be data indicative of a location of the first mobile device 804 at a given time. The location data 812 may be generated, identified, determined, selected, or otherwise collected using a software application running on the first mobile device 804. For example, the software application which provides the location data 812 may be a location services feature of the first mobile device 804. In some implementations, the location data 812 may be derived other than by using a software application running on the first mobile device 804. For example, the location data 812 can be obtained from cellular carrier towers, for example, by triangulating signals indicative of a location of the first mobile device 804.

The location data 812, once received at the server device 802, is used to query a data repository 814 at the external device 806. The data repository 814 is associated with a map application 816 and stores map information used by the map application 816. For example, the data repository 814 may be a database or other data store used to implement the map application 816. The server device 802 uses an exposed API 818 of the map application 816 to query the data repository 814. The server device 802 queries the data repository 814 based on the location data 812 received from the first mobile device 804 to identify a vendor operating at a location of the first mobile device 804.

The map application 816 is a software application run on the external device 806 or otherwise implemented using the external device 806 and which provides information about maps or locations of vendors and potentially other entities. The map application 816 may, for example, be Google Maps, Apple Maps, Waze®, Mapquest®, Yahoo! Maps, or another map application. The map information stored within the data repository 814 is information used by the map application 816 to render maps or otherwise identify locations, including without limitation, locations at which vendors operate.

After the vendor operating at the location of the first mobile device 804 is identified, an account and record validation unit 820 at the server device 802 determines whether an electronic record associated with the vendor operating at the location of the first mobile device 804 has been exposed to the first mobile device 804 or a related device. In implementations in which the system 800 includes the first mobile device 804 and the second mobile device 808, the account and record validation unit 820 can validate the user accounts of the first mobile device 804 and of the second mobile device 808 to determine that a common user account has been accessed at both of the first mobile device 804 and the second mobile device 808. The account and record validation unit 820 can determine that the common user account has been accessed at both of the first mobile device 804 and the second mobile device 808 by searching the first mobile device 804 and the second mobile device 808 for information indicating a username and a domain name of an account of an Internet-based software service. The account and record validation unit 820 can identify the common user account by comparing and matching such information from the first mobile device 804 and the second mobile device 808.

In such an implementation, after validating the common user account, the account and record validation unit 820 determines whether the second mobile device 808 has been exposed to an electronic record associated with the vendor operating at the location of the first mobile device 804. The account and record validation unit 820 determines the electronic record exposure at the second mobile device 808 using exposure data 822 stored at the second mobile device 808. For example, the exposure data 822 may be communicated to the server device 802 responsive to a request for the exposure data 822 from the server device 802. The exposure data 822 includes information stored at the second mobile device 808 from one or more Internet-based software services in which at least one is configured to display the electronic record. In particular, the exposure data 822 may be data stored in connection with a current or previous displaying of the electronic record at the second mobile device 808. In some implementations, the exposure data 822 may be other data, such as browsing data as otherwise disclosed herein, to the extent different.

Alternatively, in implementations in which the system 800 omits the second mobile device 808, the account and record validation unit 820 may validate the user accounts registered at the first mobile device and then proceed to determine whether the first mobile device 804 has been exposed to an electronic record associated with the vendor operating at the location of the first mobile device 804. The account and record validation unit 820 determines the electronic record exposure at the first mobile device 804 using exposure data 824 stored at the first mobile device 804. For example, the exposure data 824 may be communicated to the server device 802 responsive to a request for the exposure data 824 from the server device 802. The exposure data 824 includes information stored at the first mobile device 804 from one or more Internet-based software services in which at least one is configured to display the electronic record. In particular, the exposure data 824 may be data stored in connection with a current or previous displaying of the electronic record at the first mobile device 804. In some implementations, the exposure data 824 may be other data, such as browsing data as otherwise disclosed herein, to the extent different. In some implementations in which the system 800 omits the second mobile device 808, the account and record validation unit 820 may omit functionality for validating user accounts of the first mobile device 804.

Each of the exposure data 822 and the exposure data 824 may include, but is not limited to, demand data (e.g., demand side platform data or demand management platform data) or browsing data (e.g., data communicated from the first mobile device 804 or the second mobile device 808, as applicable, to the server device 802 and/or locally stored at the first mobile device 804 or the second mobile device 808, as applicable). For example, where the exposure data 822 and/or the exposure data 824 includes demand data deriving from a server associated with a demand side platform or a demand management platform, the exposure data 822 and/or the exposure data 824, as applicable, can be or include upstream data received, identified, monitored, intercepted, or otherwise obtained on its way to the server associated with the demand side platform or the demand management platform. In another example, where the exposure data 822 and/or the exposure data 824 includes browsing data, the exposure data 822 and/or the exposure data 824, as applicable, can be or include cookie data, metadata, and/or other data indicative of information processed for and/or rendered and output for display at the first mobile device 804 or the second mobile device 808, as applicable, whether as downstream data or as upstream data.

After the electronic record exposure is determined for the first mobile device 804 and/or the second mobile device 808, an intelligence platform modeling unit 826 updates an intelligence platform model based on the successful exposure campaign for the electronic record. Updating the intelligence platform model may include determining whether and/or how to influence the further use of the electronic record or otherwise reconfigure the campaign for the electronic record. For example, the update based on the successful exposure of the electronic record may cause an expansion of the electronic record exposure campaign, such as to pursue further exposure of the electronic record at other devices.

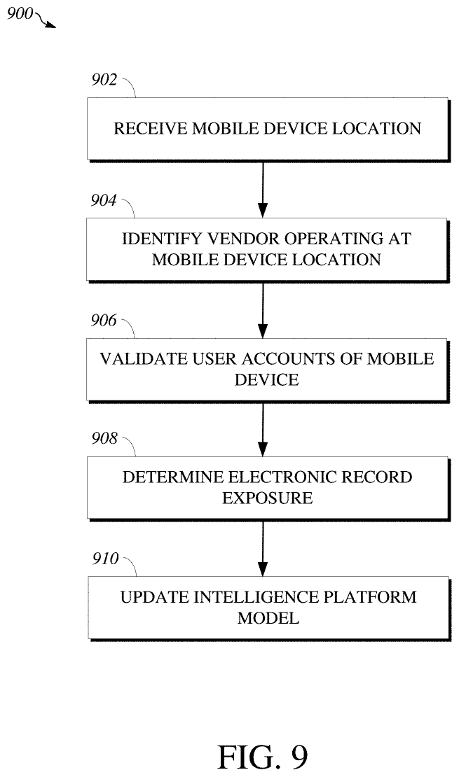

Further implementations of the disclosure will now be described with reference to FIG. 9. The steps, or operations, of any method, process, or algorithm described in connection with the embodiments disclosed herein may be embodied directly in hardware, firmware, software executed by hardware, circuitry, or a combination of these. In some implementations, the method 900 may be performed using machines and hardware such as the equipment of FIG. 8, which may in at least some cases implicate machines and hardware such as the equipment of FIGS. 1 through 5. The method 900 may be performed, for example, by executing a machine-readable program of JavaScript, C, or other such instructions. Implementations of the present disclosure may include multiple of the above-described features.

For ease of explanation, the method 900 is depicted and described as a series of operations. However, operations in accordance with this disclosure may occur in various orders and/or concurrently. Additionally, operations in accordance with this disclosure may occur with other operations not presented and described herein. Furthermore, not all illustrated operations may be required to implement a method in accordance with the disclosed subject matter.

FIG. 9 is a flowchart showing an example method 900 for using an implementation of the present disclosure for electronic record exposure validation using cross-referenced location data. At 902, a location of a mobile device is received. The location of the mobile device is received from a software application running on the mobile device. For example, the software application running on the mobile device may be or include a location services feature of the mobile device. In another example, the software application running on the mobile device may be a background application other than a location services feature which collects location data of the mobile device. In yet another example, the software application running on the mobile device may be a mobile application which collects location data of the mobile device. The location of the mobile device is transmitted from the software application to a server device. For example, the software application which collects the location data may transmit the location of the mobile device to the server device. Receiving the location of the mobile device further includes parsing the data indicative of the location of the first mobile device to identify latitude and longitude coordinates of the first mobile device. In some implementations, the location of the mobile device as received may be or include latitude and longitude coordinates of the mobile device.

At 904, a vendor operating at the location of the mobile device is identified.

Identifying the vendor operating at the location of the mobile device includes querying a data repository external to the mobile device based on the location of the mobile device to identify the vendor. The data repository is associated with a map application and stores map information indicating geolocations of vendors. Querying the data repository can include using an exposed API of the map application associated with the data repository to pass a request, such as a hypertext transfer protocol request, to the map application to search for possible vendors using the identified latitude and longitude coordinates of the first mobile device. In this way, the location of the mobile device can be cross-referenced against the map information used by the map application. In response to the request, latitude and longitude coordinates of the vendor operating at the location of the mobile device can be received from the map application. A match can then be identified between the location of the mobile device and the location of the vendor responsive to a comparison between the latitude and longitude coordinates of the vendor and the latitude and longitude coordinates of the mobile device.

At 906, user accounts of the mobile device are validated. Validating the user accounts of the mobile device includes identifying user account information registered with the mobile device. For example, the user account information may be registered directly with the mobile device or may be identifiable based on a previous accessing of the user account on the mobile device. The user account is a user account of an Internet-based software service. The user account may be an email account, a social media platform account, a financial platform account, an account on a special interest website, or another user account. Identifying the user account, such as by registration at the mobile device or otherwise, may include accessing accounts information or related data at the mobile device to identify a username and a domain of the user account, in which the domain identifies the Internet-based software service and the username identifies the account specific to the user of the mobile device.

In some implementations, the validation of the user accounts of the mobile device may be performed to determine a common user account shared between the mobile device, as a first mobile device, and a second mobile device. For example, as will be further described below, in some implementations of the method 900, the method 900 is performed to determine an exposure of an electronic record at a second mobile device responsive to an identification of a first mobile device shared by a user of the second mobile device at a location of a vendor, in which the electronic record to which the second mobile device is exposed is an electronic record of that same vendor. In some such implementations, validating the user account includes validating that a common user account has been accessed at both of the first mobile device and the second mobile device. This may include identifying user account information registered with each of the first mobile device and the second mobile device. For example, account data or related information at each of the first mobile device and the second mobile device can be identified and compared to identify a common user account accessed at both of the first mobile device and the second mobile device.

The common user account validates a common ownership of the first mobile device and the second mobile device. In this way, the common user account validates that information to which the second mobile device is exposed resulted in an exposure of the common user of the first mobile device and the second mobile device to an electronic record. Accordingly, by validating a common user account between a first mobile device located at a location of a vendor and a second mobile device to which an electronic record associated with that vendor was previously exposed, a conclusion can be reached as to a success of the electronic record exposure with respect to the user of the first mobile device located at the location of the vendor.

At 908, electronic record exposure is determined. In implementations in which the method 900 is performed with respect to a single mobile device, the electronic record exposure is determined using exposure data for the single mobile device (e.g., using the exposure data 824 shown in FIG. 8). For example, determining the electronic record exposure may, when the exposure data includes browsing data, include searching the single mobile device for exposure data indicative of the electronic record. In another example, determining the electronic record exposure may, when the exposure data includes demand data, include obtaining demand data indicating electronic records processed for and/or rendered and output for display at the single mobile device. The exposure data is information associated with a previous exposure of the electronic record to the mobile device, for example, by the mobile device being used to view a website, an email, or other digital content within which the electronic record was displayed. In implementations in which the method 900 is performed with respect to a first mobile device and a second mobile device in which the first mobile device is located at the location of the vendor and the second mobile device shares a common user account with the first mobile device, the electronic record exposure is determined using exposure data for the first mobile device and/or for the second mobile device (e.g., using the exposure data 822 shown in FIG. 8 and/or the exposure data 824). For example, determining the electronic record exposure may, when the exposure data includes browsing data, include searching the first and/or second mobile device for exposure data indicative of the electronic record. In another example, determining the electronic record exposure may, when the exposure data includes demand data, include obtaining demand data indicating electronic records processed for and/or rendered and output for display at the first mobile device and/or at the second mobile device.

At 910, responsive to determining the electronic record exposure, an intelligence platform model is updated to indicate a successful exposure of the electronic record. The intelligence platform model is a model of an intelligence platform used for electronic record exposure and validation. The model may, for example, be an analysis tool which analyzes the efficacy of electronic record exposure campaigns, for example, based on the detection of a mobile device at a location of a vendor associated with an electronic record after the exposure of the electronic record at the mobile device or at another mobile device sharing a user with the device detected as being located at the location of the vendor. Updating the intelligence platform model can include updating a recommendation engine associated with the intelligence platform model according to the successful exposure of the electronic record.

The updating of the recommendation engine may influence the further use of the electronic record or otherwise reconfigure the campaign for the electronic record. For example, the update to the recommendation engine based on the successful exposure of the electronic record may cause an expansion of the electronic record exposure campaign, such as to pursue further exposure of the electronic record at other devices. For example, based on the update to the recommendation engine, data configured to cause an exposure of the electronic record may be transmitted to a new (e.g., third) mobile device unrelated to the common user account earlier validated. The data configured to cause the exposure of the electronic record to the new mobile device includes programmable instructions operable, for example, on a website, to cause an exposure of the electronic record to the new mobile device.

In some implementations, the validation of the user accounts at the mobile device may be performed other than after the identification of the vendor operating at the location of the mobile device and/or other than before the determination of the electronic record exposure. For example, the user accounts registered on the mobile device may be validated before the location of the mobile device is received. In another example, the user accounts registered on the mobile device may be validated after the location of the mobile device is received and before the vendor operating at the location of the mobile device is identified.

In some implementations in which the method 900 is performed with respect to a single mobile device rather than using two mobile devices (e.g., wherein the mobile device location is received from a first mobile device and the electronic record exposure is determined for a second mobile device), the validation of the user accounts at the mobile device may be omitted. For example, the determination of electronic record exposure may be responsive to the identification of the vendor operating at the location of the mobile device. In some such implementations, the determination of electronic record exposure may instead be before the location of the mobile device is received. For example, data indicating electronic records to which the mobile device is exposed may be obtained and stored at a first time and later processed responsive to receipt of the location of the mobile device at the location of the vendor. Such later processing may, for example, include determining whether previously stored electronic record exposure data corresponds to the vendor identified at the location of the mobile device.

In some implementations, the electronic record may be an electronic record other than that of the same vendor identified as operating at the location of the mobile device. For example, the electronic record may correspond to goods and/or services of a particular industry or type. In such a case, the electronic exposure may be deemed successful, and the intelligence platform model may be updated accordingly, responsive to a determination that the vendor operating in the location of the mobile device provides the same or substantially similar goods and/or services as are referred to within the electronic record. Determining that a vendor operating in the location of the mobile device provides certain goods and/or services can include searching the name of the vendor obtained, for example, from the map application online to identify a website. A data parser can automatically review a website identified using web crawlers to determine an industry or type of goods and/or services provided by the vendor. The industry or type of goods and/or services determined using the web crawlers may then be cross-referenced against the goods and/or services related to the electronic record to which the mobile device is exposed.

While the foregoing disclosure shows a number of illustrative embodiments, it will be apparent to those skilled in the art that various changes and modifications can be made herein without departing from the scope of the disclosure as defined by the appended claims. Accordingly, the disclosed implementations are representative of the subject matter which is broadly contemplated by the present disclosure, and the scope of the present disclosure fully encompasses other embodiments which may become obvious to those skilled in the art, and that the scope of the present disclosure is accordingly to be limited by nothing other than the appended claims.

All structural and functional equivalents to the elements of the above-described embodiments that are known or later come to be known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims.

The word “example” is used herein to mean serving as an example, instance, or illustration. Any aspect or design described herein as “example” is not necessarily to be construed as preferred or advantageous over other aspects or designs. Rather, use of the word “example” is intended to present concepts in a concrete fashion. As used in this application, the term “or” is intended to mean an inclusive “or” rather than an exclusive “or”. That is, unless specified otherwise, or clear from context, “X includes A or B” is intended to mean any of the natural inclusive permutations. That is, if X includes A; X includes B; or X includes both A and B, then “X includes A or B” is satisfied under any of the foregoing instances. In addition, the articles “a” and “an” as used in this application and the appended claims should generally be construed to mean “one or more” unless specified otherwise or clear from context to be directed to a singular form. Moreover, use of the term “an implementation” or “one implementation” throughout is not intended to mean the same implementation unless described as such.

Furthermore, although elements of the disclosure may be described or claimed in the singular, reference to an element in the singular is not intended to mean “one and only one” unless explicitly so stated, but shall mean “one or more.” Additionally, ordinarily skilled artisans will recognize in view of the present disclosure that while operational sequences must be set forth in some specific order for the purpose of explanation and claiming, the present disclosure contemplates various changes beyond such specific order.

In addition, those of ordinary skill in the relevant art will understand that information and signals may be represented using a variety of different technologies and techniques. For example, any data, instructions, commands, information, signals, bits, symbols, and chips referenced herein may be represented by voltages, currents, electromagnetic waves, magnetic fields or particles, optical fields or particles, other items, or a combination of the foregoing.

Moreover, ordinarily skilled artisans will appreciate that any illustrative logical blocks, modules, circuits, and process steps described herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure.

The foregoing description describes only some examples of implementations of the described techniques. Other implementations are available. For example, the particular naming of the components, capitalization of terms, the attributes, data structures, or any other programming or structural aspect is not mandatory or significant, and the mechanisms that implement the systems and methods described herein or their features may have different names, formats, or protocols. Further, the system may be implemented via a combination of hardware and software, as described, or entirely in hardware elements. Also, the particular division of functionality between the various system components described herein is merely by example, and not mandatory; functions performed by a single system component may instead be performed by multiple components, and functions performed by multiple components may instead performed by a single component.

It is to be understood that the present disclosure is not to be limited to the disclosed implementations but, on the contrary, is intended to cover various modifications and equivalent arrangements included within the scope of the appended claims.

What is claimed is:

1. A method, comprising:
receiving a location of a first mobile device from a software application running on the first mobile device;
querying a data repository external to the first mobile device based on the location of the first mobile device to identify a vendor operating at the location of the first mobile device;
responsive to the identification of the vendor, determining whether a second mobile device has been exposed to an electronic record associated with the vendor, wherein the first mobile device and the second mobile device are shared by a common user account previously accessed at both of the first mobile device and the second mobile device; and
responsive to a determination that the second mobile device has been exposed to the electronic record, updating an intelligence platform model to indicate a successful exposure of the electronic record to a user associated with the common user account.

2. The method of claim 1, wherein receiving the location of the first mobile device from the software application running on the first mobile device comprises:
receiving data indicative of the location of the first mobile device from the software application running on the first mobile device; and
parsing the data indicative of the location of the first mobile device to identify latitude and longitude coordinates of the first mobile device.

3. The method of claim 2, wherein the data repository stores map information indicating geolocations of vendors, wherein querying the data repository external to the first mobile device based on the location of the first mobile device to identify the vendor operating at the location of the first mobile device comprises:
using an exposed application programming interface of a map application associated with the data repository, passing a hypertext transfer protocol request to the map application to search for possible vendors using the identified latitude and longitude coordinates of the first mobile device.

4. The method of claim 3, further comprising:
receiving, from the map application in response to the hypertext transfer protocol request, latitude and longitude coordinates of the vendor operating at the location of the first mobile device; and
identifying a match between the location of the first mobile device and the location of the vendor responsive to a comparison between the latitude and longitude coordinates of the vendor and the latitude and longitude coordinates of the first mobile device.

5. The method of claim 4, further comprising:
responsive to identifying the match, validating that the common user account has been accessed at both of the first mobile device and the second mobile device by identifying user account information registered with each of the first mobile device and the second mobile device.

6. The method of claim 5, wherein determining whether the second mobile device has been exposed to the electronic record associated with the vendor comprises:
responsive to validating that the common user account has been accessed at both of the first mobile device and the second mobile device, obtaining exposure data for the second mobile device, wherein the exposure data is indicative of the electronic record.

7. The method of claim 6, wherein updating the intelligence platform model to indicate the successful exposure of the electronic record to the common user account comprises:
updating a recommendation engine associated with the intelligence platform model according to the successful exposure; and
transmitting, based on the update to the recommendation engine, data configured to cause an exposure of the electronic record to a third mobile device unrelated to the common user account.

8. The method of claim 7, wherein the data configured to cause the exposure of the electronic record to the third mobile device includes programmable instructions operable on a website to cause an exposure of the electronic record to the third mobile device.

9. The method of claim 2, wherein the software application is a location services feature of the first mobile device.

10. The method of claim 1, wherein the first mobile device is a wearable device and the second mobile device is a smartphone device.

11. A method, comprising:
transmitting, from a server device, a request for location data to a first mobile device running a software application;
responsive to the request for the location data, receiving, at the server device, the location data from the first mobile device;
parsing, at the server device, the location data from the mobile device to identify a location of the first mobile device;
cross-referencing, at the server device, the location of the first mobile device against locations of vendors to identify a vendor operating at the location of the first mobile device using map information of a map application running on an external device;
determining that the first mobile device is related to a second mobile device by validating a common user account accessed at both of the first mobile device and the second mobile device;
transmitting, from the server device, a request for exposure data for a second mobile device, the exposure data including data based on an exposure, at the second mobile device, of an electronic record associated with the vendor operating at the location of the first mobile device;
responsive to the request for the exposure data for the second mobile device, receiving, at the server device, the exposure data; and
processing, at the server device, the exposure data for the second mobile device to determine a successful exposure of a user of the first mobile device and of the second mobile device to the electronic record.

12. The method of claim 11, further comprising:
updating an intelligence platform model to indicate the successful exposure of the electronic record to the user of the first mobile device and of the second mobile device.

13. The method of claim 11, wherein cross-referencing the location of the first mobile device against the locations of vendors to identify the vendor operating at the location of the first mobile device using the map information of the map application running on the external device comprises:
querying, using an exposed application programming interface of the map application, a data repository storing the map information using the location of the first mobile device.

14. The method of claim 13, wherein the location of the first mobile device is expressed in the query as a latitude and longitude of the first mobile device, wherein cross-referencing the location of the first mobile device against the locations of vendors to identify the vendor operating at the location of the first mobile device using the map information of the map application running on the external device further comprises:
matching, using results of the querying, the latitude and longitude of the first mobile device to a latitude and longitude of the vendor according to the map information.

15. The method of claim 11, wherein determining that the first mobile device is related to the second mobile device by validating the common user account accessed at both of the first mobile device and the second mobile device comprises:
identifying user account information registered with each of the first mobile device and the second mobile device.

16. The method of claim 15, wherein the common user account is validated before the request for location data is transmitted to the first mobile device.

17. The method of claim 11, wherein the first mobile device is a smartphone device and the second mobile device is a tablet device.

18. A method, comprising:
determining, based on exposure data for a mobile device, that the mobile device has been exposed to an electronic record;
detecting, based on location data received from a software application running on the mobile device, a location of the mobile device;
identifying, by querying for map information used by a map application, a vendor operating at the location of the mobile device, wherein the vendor is associated with the electronic record; and
updating, based on the identification of the vendor, an intelligence platform model to cause a further exposure of the electronic record to one or more other devices.

19. The method of claim 18, wherein the mobile device is a first mobile device, the method further comprising:
determining that a second mobile device is related to the first mobile device based on a common user account accessed at both of the first mobile device and the second mobile device; and
determining, based on exposure data for the second mobile device, that the second mobile device has been exposed to the electronic record,
wherein the updating of the intelligence platform model is responsive to the determination that the second mobile device has been exposed to the electronic record and to the identification of the vendor operating at the location of the first mobile device.

20. The method of claim 18, wherein identifying the vendor operating at the location of the mobile device comprises:
using an exposed application programming interface of the map application to cross-reference the location of the mobile device against locations of vendors known to the map application.
